(19) United States
(12) Patent Application Publication
(10) Pub. No.: US 2017/0095736 A1
(43) Pub. Date: Apr. 6, 2017

(54) SYSTEM, METHOD, and COMPUTER PROGRAM FOR PROVIDING A TIME BASED MEDIA CONTEST PLATFORM

(71) Applicants: Giovanni Maria Giro, Key Biscayne, FL (US); Filippo Cingolani, Key Biscayne, FL (US)

(72) Inventors: Giovanni Maria Giro, Key Biscayne, FL (US); Filippo Cingolani, Key Biscayne, FL (US)

(21) Appl. No.: 14/949,025

(22) Filed: Nov. 23, 2015

Related U.S. Application Data
(60) Provisional application No. 62/237,767, filed on Oct. 6, 2015.

(51) Int. Cl. A63F 13/352; A63F 13/335; H04W 4/02; G06Q 20/10; G06F 17/30

(52) U.S. Cl. CPC A63F 13/352; G06Q 20/102; G06F 17/30864; H04W 4/02; A63F 13/335; G06Q 2230/00

(57) ABSTRACT

The present invention is directed to method(s), system(s), and computer program(s) for providing a time based media contest platform. Specifically, user(s) of the platform may participate in one or more contests by submitting user media to an application server during a predefined contest period. The media for each contest is voted on by other users. Upon expiration of a contest period, the winners of the contest are selected and are notified automatically. In one embodiment, participating user(s) may be required to purchase a contest entry via a virtual currency accepted by the application server. In one embodiment, various notifications, filters and/or search operations may be requested by a user for different contests.

### CLAIM OF PRIORITY

This application claims priority to U.S. Provisional Application No. 62/237,767, filed on Oct. 6, 2015.

### BACKGROUND OF THE INVENTION

Field of the Invention

The present invention generally relates to a system, method, and computer program for providing a time based media contest platform based on user generated content.

Description of the Related Art

Today, online technology and interconnected social platforms support a vast number of options for providing user generated media content. As such, user generated content has been leveraged in marketing, such as in contest promotions for the marketing of various services and products; interactions with a brand via social media, i.e. for “likes” on Facebook or other social platforms for enhanced visibility. In this aspect, customer submitted photos, videos, or other creations relate to and promote a brand. These types of promotions may typically be combined a contest or rewards as incentives for user or customer participation. The benefits of this type of marketing include lower cost, direct engagement with a customer base, and the receipt of user generated content that may then be utilized for future marketing campaigns.

These user generated content have also been used as a reference for discovering new talent, and as recreation and entertainment. For example, video platforms such as YouTube or Twitch TV serve as a gateway for many users to broadcast themselves, and for other users to engage with the broadcasters, as a growing mode of entertainment. The present invention contemplates leveraging these areas together, in the provision of a time-based media contest platform to provide greater engagement and incentives for providing user generated content.

### SUMMARY OF THE INVENTION

The present invention is generally directed to a time-based media contest platform and accompanying systems, methods, and computer programs thereof.

Specifically, user(s) of the present invention may participate in one or more contests by submitting user media to an application server during a predefined contest period. The media for each contest is voted on by other users during this period. Upon expiration of the contest period, the winners of a contest are selected and notified automatically, depending on the votes collected, i.e. the highest voted content wins. In one embodiment, a virtual currency purchase is required as a fee or precondition for a contest entry.

In various embodiments, user(s) may view upcoming, live, and past contests and may be able to filter these contests by various filter parameters such as prize, contest type, location. User(s) may also be able to search for other user(s) via a search functionality and view their respective media entries. User(s) may set select notifications based for upcoming contest notification, geolocation based contest notification, notifications for winning challenge(s), and other appropriate notifications.

A contest or Challenge may be created by a user of the platform, a merchant or advertising user who pays the platform a certain fee, or by an administrator. A contest or Challenge may relate to a product or brand, or may relate to various categories, such as sports or arts, or may merely comprise an instruction line such as “do a funny dance”, “tell a joke”, “sing a song related to X Y Z”, for engaging a user base.

These and other objects, features and advantages of the present invention will become clearer when the drawings as well as the detailed description are taken into consideration.

### BRIEF DESCRIPTION OF THE DRAWINGS

For a fuller understanding of the nature of the present invention, reference should be had to the following detailed description taken in connection with the accompanying drawings in which:

FIG. 1 is a diagrammatic representation of an exemplary system for providing a time based media contest platform of the present invention.

FIG. 2 is an exemplary user interface of a mobile application for providing a time based media contest platform of the present invention, illustrating end user functionality.

FIG. 3 is an exemplary user interface of a mobile application for providing a time based media contest platform of the present invention, illustrating end user functionality related to upcoming events.

FIG. 4 is an exemplary user interface of a mobile application for providing a time based media contest platform of the present invention, illustrating end user functionality related to upcoming events.

FIG. 5 is an exemplary user interface of a mobile application for providing a time based media contest platform of the present invention, illustrating end user functionality.

FIG. 6 is an exemplary user interface of a mobile application for providing a time based media contest platform of the present invention, illustrating end user functionality.

FIG. 7 is an exemplary user interface of a mobile application for providing a time based media contest platform of the present invention, illustrating end user functionality.

FIG. 8 is an exemplary user interface of a mobile application for providing a time based media contest platform of the present invention, illustrating end user functionality.

FIG. 9 is an exemplary user interface of a mobile application for providing a time based media contest platform of the present invention, illustrating end user functionality.

FIG. 10A is an exemplary user interface of a mobile application for providing a time based media contest platform of the present invention, illustrating end user functionality.

FIG. 10B is an exemplary user interface of a mobile application for providing a time based media contest platform of the present invention, illustrating end user functionality.

FIG. 11 is an exemplary user interface of a mobile application for providing a time based media contest platform of the present invention, illustrating end user functionality.

FIG. 12 is an exemplary user interface of a mobile application for providing a time based media contest platform of the present invention, illustrating end user functionality.

FIG. 13 is an exemplary user interface of a mobile application for providing a time based media contest platform of the present invention, illustrating end user functionality.

FIG. 14 is an exemplary user interface of a mobile application for providing a time based media contest platform of the present invention, illustrating end user functionality.

FIG. 15 is an exemplary user interface of a mobile application for providing a time based media contest platform of the present invention, illustrating end user functionality.

FIG. 16 is an exemplary user interface of a mobile application for providing a time based media contest platform of the present invention, illustrating end user functionality.

FIG. 17 is an exemplary user interface of a mobile application for providing a time based media contest platform of the present invention, illustrating end user functionality.

FIG. 18 is an exemplary user interface of a mobile application for providing a time based media contest platform of the present invention, illustrating end user functionality.

FIG. 19 is an exemplary user interface of a mobile application for providing a time based media contest platform of the present invention, illustrating end user functionality.

FIG. 20 is an exemplary user interface of a mobile application for providing a time based media contest platform of the present invention, illustrating end user functionality.

FIG. 21 is an exemplary user interface of a mobile application for providing a time based media contest platform of the present invention, illustrating end user functionality.

FIG. 22 is an exemplary user interface of a mobile application for providing a time based media contest platform of the present invention, illustrating end user functionality.

FIG. 23 is an exemplary user interface of a mobile application for providing a time based media contest platform of the present invention, illustrating end user functionality.

FIG. 24 is a flow chart directed to a method of the present invention.

Like reference numerals refer to like parts throughout the several views of the drawings.

### DETAILED DESCRIPTION OF THE PREFERRED EMBODIMENT

As schematically represented in the accompanying drawings, the present invention is generally directed to a time based media contest platform.

### A. Overview of Implementation System(s)

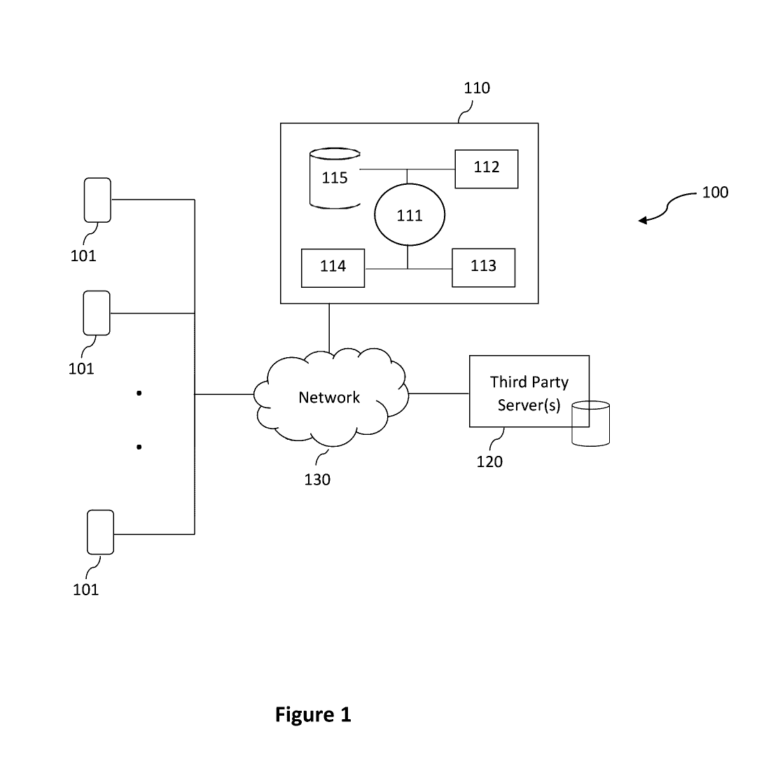

In one embodiment, a contest platform of the present invention may be deployed as a software as a service (SaaS) in accordance with implementation on a system 100 as generally represented in FIG. 1. Accordingly, the system 100 of the present invention generally comprises at least one client device or device 101 communicably connected to an application server 110 over a network 130. One or more third party server(s) 120 may further be communicably connected to the application server 110 and the at least one device 101 over the same network 130.

The device 101 may comprise a mobile device, a tablet, a computer, a wearable electronic device, or any other device or combination of circuits structured and configured to communicate with another device, computer, or server over the network 130. The device 101 may comprise application(s) and user interface(s) (front-end interface) that allows a user to interact with the application server 110 and any third party server(s) 120 and stored applications and programs thereon (back-end processing). The user interface may be proprietary and may comprise a custom developed mobile or desktop application(s). Alternatively, or in addition to, the user interface may comprise a web browser, mobile browser, or other application or executable code that allows for communication and visualization of information.

The term “application server” 110, “third party server” 120 refer to at least one computer having appropriate hardware and applications installed thereon for the provision of server services including web and other functional services described herein, such that a user may access, execute, and/or view the applications remotely from a device 101. More specifically, the application server 110 and third party server(s) 120 may comprise general purpose computers, specialized computers, or other hardware components structured and configured to receive, process, transmit, and store information to and from other devices. The application server 110 is further configured with executable or interpretable computer code that allows it to perform the processes described within this application.

For example, the application server 110 may comprise a general purpose computer comprising a central processing unit (CPU) 111, which may be a single core or multi core processor, memory 114 (random-access memory, read-only memory, and/or flash memory) or primary memory for high-speed storage of executing programs, electronic storage unit 115 (e.g., hard disk) or secondary memory for storing data, communications interface 112 (e.g., network adapter) for communicating with other devices or computers over a network, and/or peripheral device(s) 113 in communication with the CPU 111 that enable input/output of the application server 110.

The application server 110 may implement the methodology of the present invention using any number of solution stacks (a set of software subsystems or components) known to an ordinary computer or web programmer skilled in the art. These solution stacks may include, without limitation, ZEND Server, APACHE Server, NODE.JS, ASP, PHP, Ruby, XAMPP, LAMP, WAMP, MAMP, WISA, LEAP, GLASS, LYME, LYCE, OpenStack, Ganeti, MEAN, MEEN, XRX, and other past, present, or future equivalent solution stacks, or combinations thereof, known to those skilled in the art that allows a programmer to develop the methods and computer programs described within this application. The software stack might be implemented without third-party cloud platforms, for example using load balancing and virtualization software provided by Citrix, Microsoft, VMware, Map-Reduce, Google Filesystem, Xen, memory caching software such as Memcached and Membase, structured storage software such as MySQL, MariaDB, XtraDB, etc. and/or other appropriate platforms. Of course, these solution stacks may also be deployed in cloud platforms by using known development tools and server hosting services such as GitHub and Rackspace, as well as their equivalents.

The third party server(s) 120 may comprise any combination of hardware and software (code segments in any number of programmable, executable, or interpretable languages that support the functionality of the methods described herein) configured to host and transmit calendar items of a user. The third party server(s) 120 may be configured to communicate directly to the application server 110 via application programming interfaces or upon the request of a user.

User account services may be implemented using one or more solution stacks as described above. Alternatively, third party login services such as Facebook, Twitter, LinkedIn, Google and other related services, may be utilized for user account login and authentication, such as via existing third party server(s) 120 of other parties.

The network 130 may comprise at least two computers in communication with each other, which may form a data network such as via LAN, WAN, Serial, Z-WAVE, ZIGBEE, RS-485, MODBUS, BACNET, the Internet, or combinations thereof. The connections may be facilitated over various wired and/or wireless mediums or any combination thereof including interconnections by routers and/or gateways. Network 130 may comprise additional hardware components and/or devices appropriate for facilitating the transmission and communication between the various systems and devices of the present invention, such as those directed to integrated authentication, quality control or to improve content delivery such as via a content delivery network (CDN).

Various aspects of the present invention may be thought of as “products” or “articles of manufacture” typically in the form of machine (or processor) executable code, interpretable code, and/or associated data that is carried on or embodied in a machine readable medium. Machine-executable code can be stored on an electronic storage unit, such memory (e.g., read-only memory, random-access memory, flash memory) or a hard disk, as described above.

All or portions of the software may at times be communicated through the Internet or other communication networks. Such communications, for example, may enable loading of the software from one computer or processor onto another, for example, from a management server or host computer onto the computer platform of an application server, or from an application server onto a client computer or device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, tangible “storage” media, terms such as computer or machine “readable medium”, refer to any medium that participates in providing instructions to a processor for execution. Further, the term “non-transitory” computer readable media includes both volatile and non-volatile media, including RAM. In other words, non-transitory computer media excludes only transitory propagating signals per se, but includes at least register memory, processor cache, RAM, and equivalents thereof.

Therefore, a machine readable medium, such as computer-executable code and/or related data structures, may take many forms, including but not limited to, a tangible storage medium, a carrier wave medium or physical transmission medium. Non-volatile storage media include, for example, optical, magnetic, or solid state disks, such as any of the storage devices in any computer(s) or the like, such as may be used to house the databases. Volatile storage media include dynamic memory, such as main memory of such a computer platform. Tangible transmission media may include coaxial cables, copper wire and fiber optics, communication buses. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

### B. Overview of the Time Based Media Contest Platform

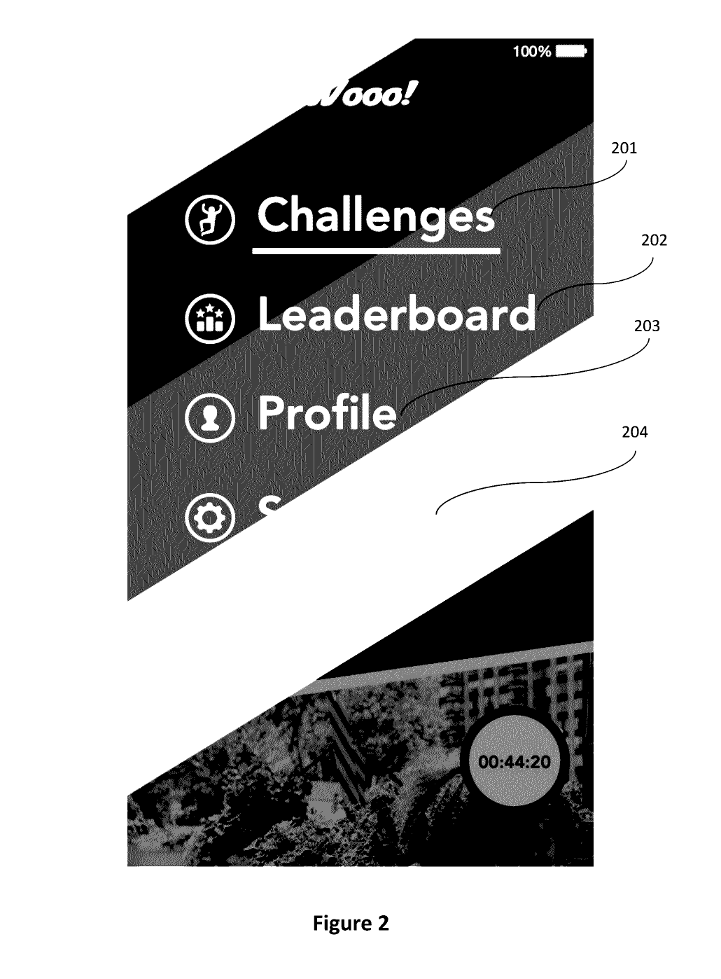

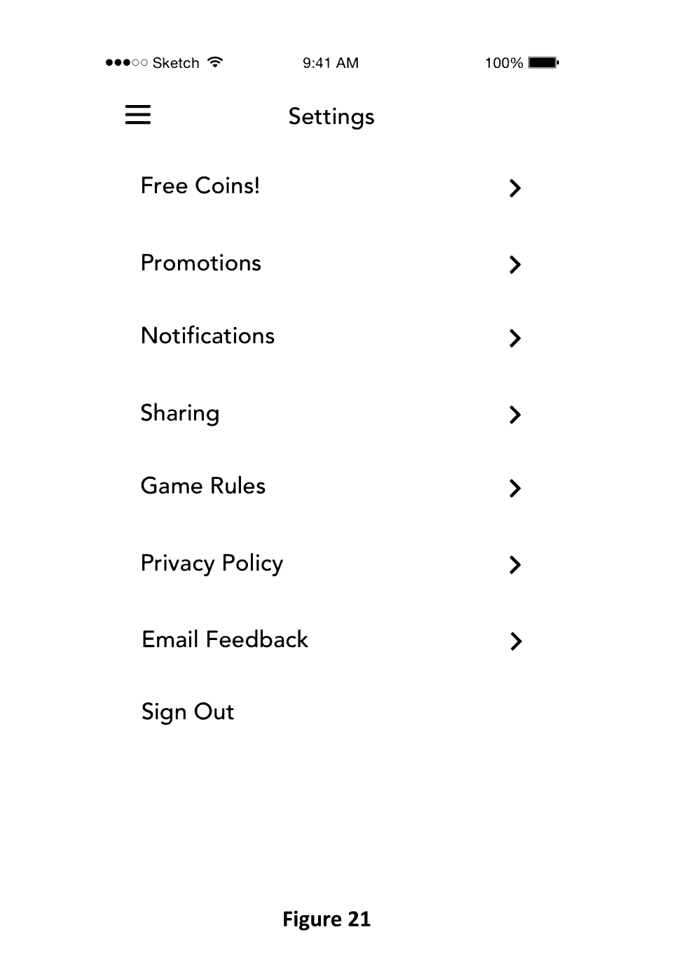

Drawing attention to FIGS. 2-23, embodiments of the present time based media contest platform are illustrated from an end user's perspective. In initially broad terms, the present invention provides for a time based media contest platform. That is, users compete within pre-defined parameters of a contest (or “Challenges”), and winner(s) having the best media submissions are selected at the end of the contest.

Drawing attention to FIG. 2, the present invention may initially comprise a navigation overlay that may appear upon user interaction with a menu button, allowing a user to view Challenges 201, Leaderboard 202, Profile 203, and Settings 204. This overlay or menu may be retrieved from interaction with a menu button on a device, such as a mobile device described above.

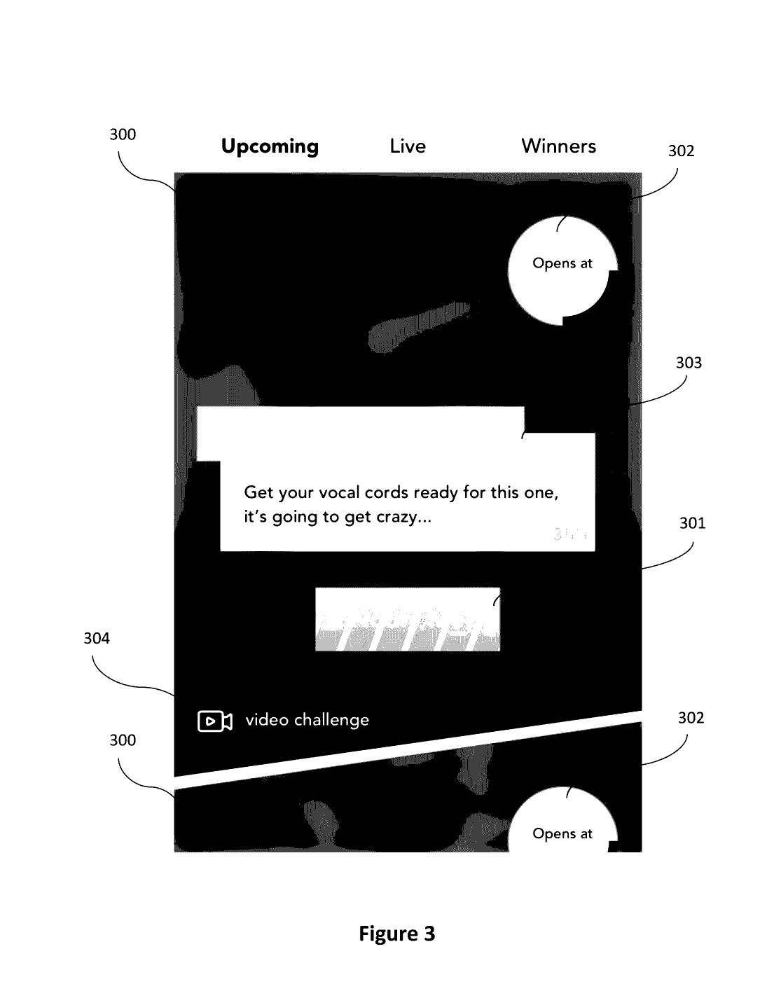

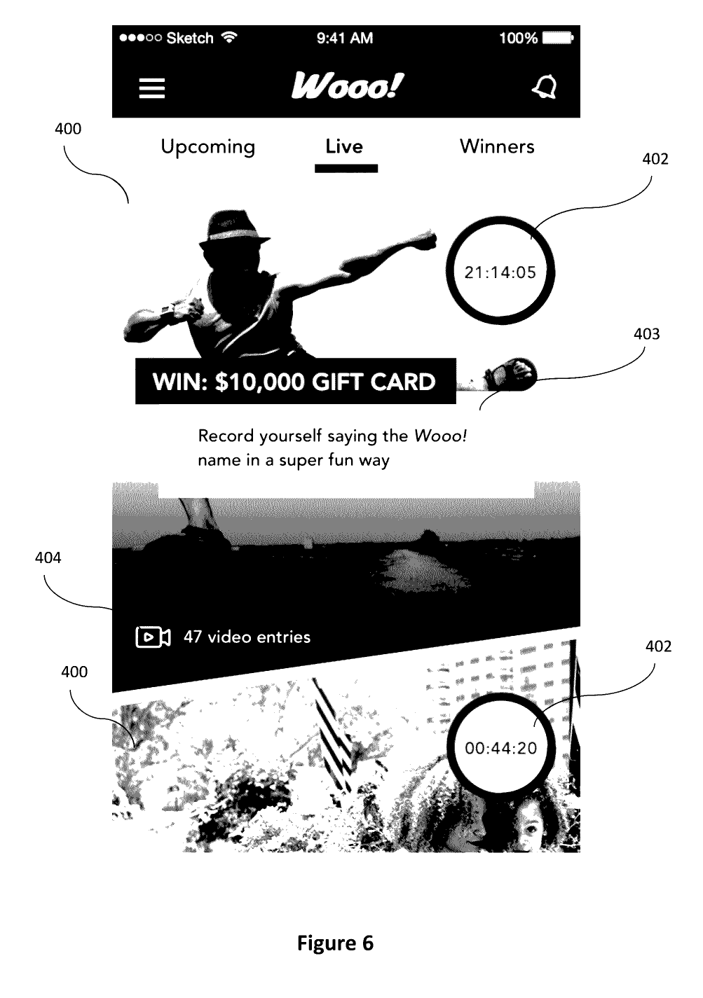

Upon navigating to Challenges 201, a user may be directed to a Live View (FIG. 6), or Upcoming View (FIG. 3), of various contests (i.e. “Challenges”) a user may participate in immediately, or receive notifications for upon or approaching its start time, respectively.

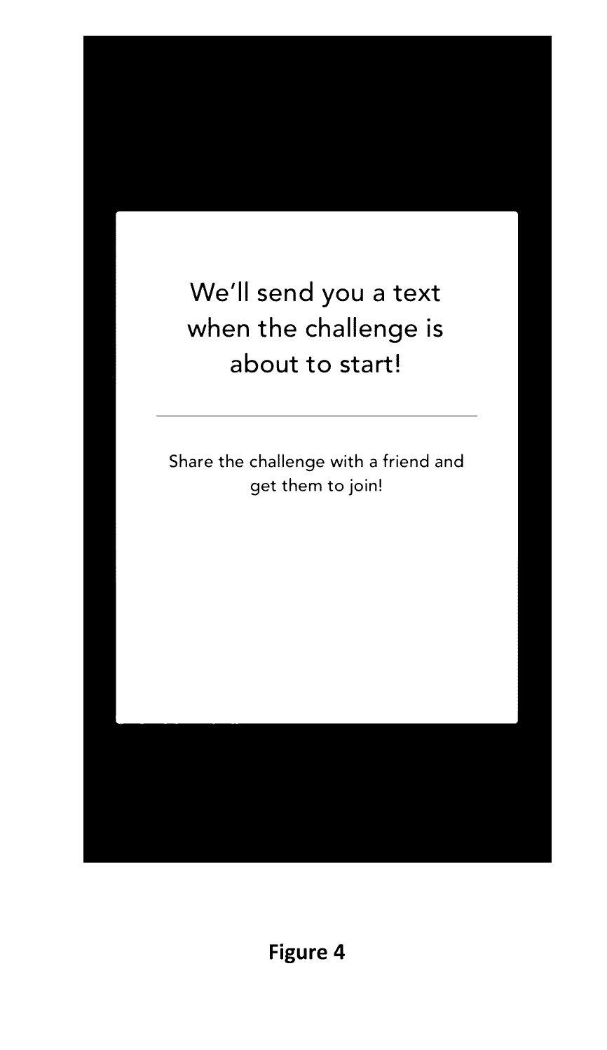

In an Upcoming View as illustrated by FIG. 3, a list of upcoming contests 300 may be provided in a list or scrollable view. For each contest, a contest period may be illustrated at 302 indicating the time and/or date that a contest may begin and/or end, a description of the contest prize (money prizes, goods or services, gift cards, vacations, etc.) and/or requirements may be illustrated as at 303, and a media type of the challenge (i.e. video, images, and/or sound) may be illustrated as at 304. A user may request notification of the challenge or contest, as at 301 and further illustrated at FIG. 4, by social media notification, text message notification, email notification, push notification, and/or other notification methods from a mobile or computing device known to those skilled in the art. A user may also share information about a challenge via one or more social media platforms known to those skilled in the art, such as via Facebook, Twitter, Instagram, and others.

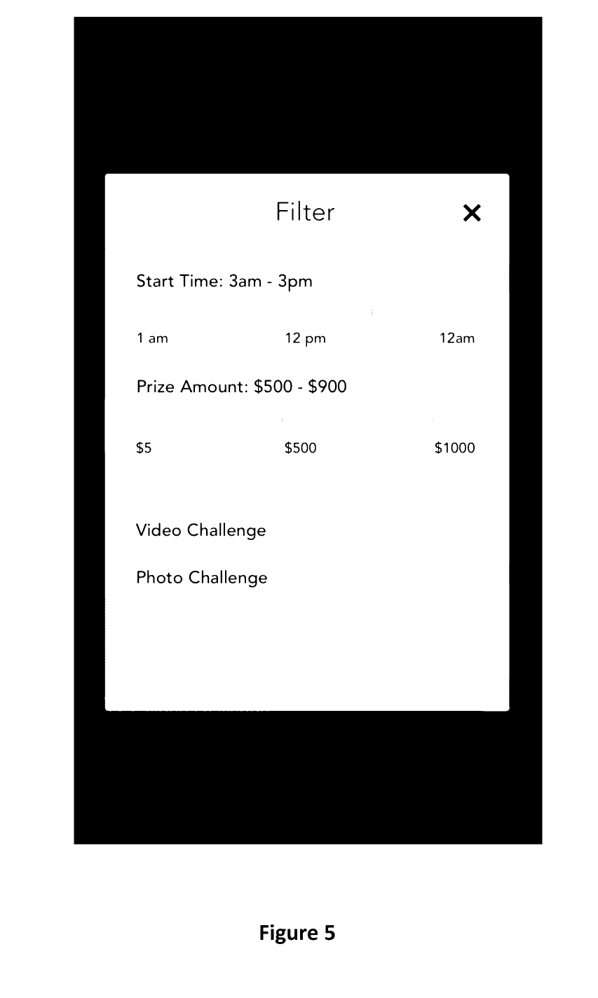

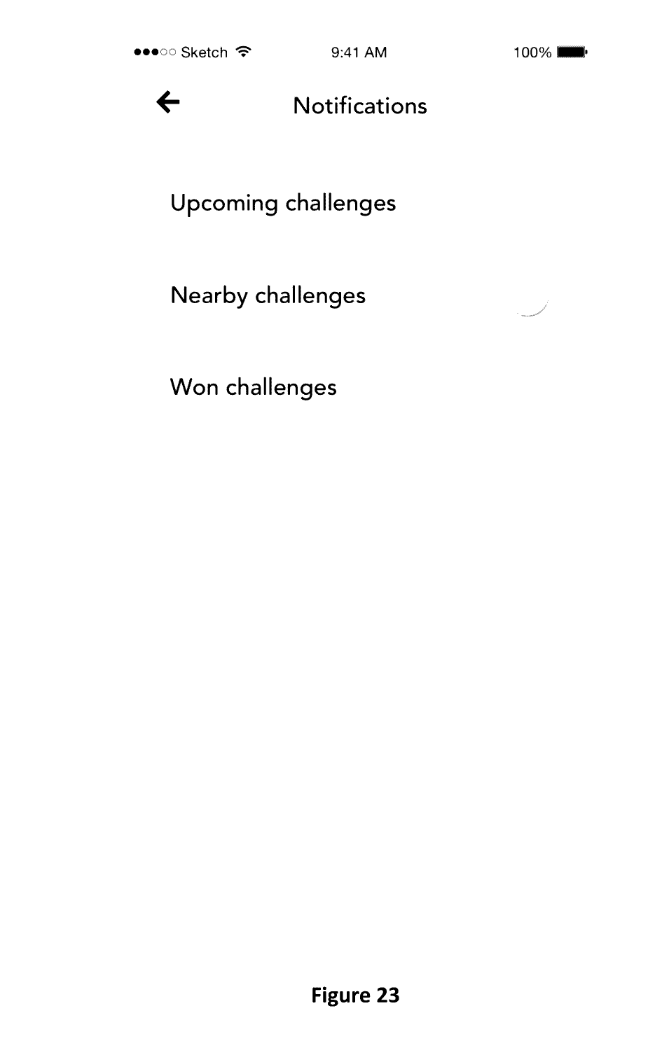

Drawing attention to FIG. 5, a user may filter a listing of Upcoming and/or Live contests or challenges available to the user. The filtration or filtering of the listing may be performed via at least one filter parameter, including but not limited to: start time, prize amount, video challenge, photo challenge, or other media-type challenge. In one embodiment and as illustrated by FIG. 23, notifications may be based on “Nearby challenges”, or based on a geolocation of a user's device such as by GPS or WiFi, and then providing the user's with a list of challenges or contests in proximity to the location of the user's device.

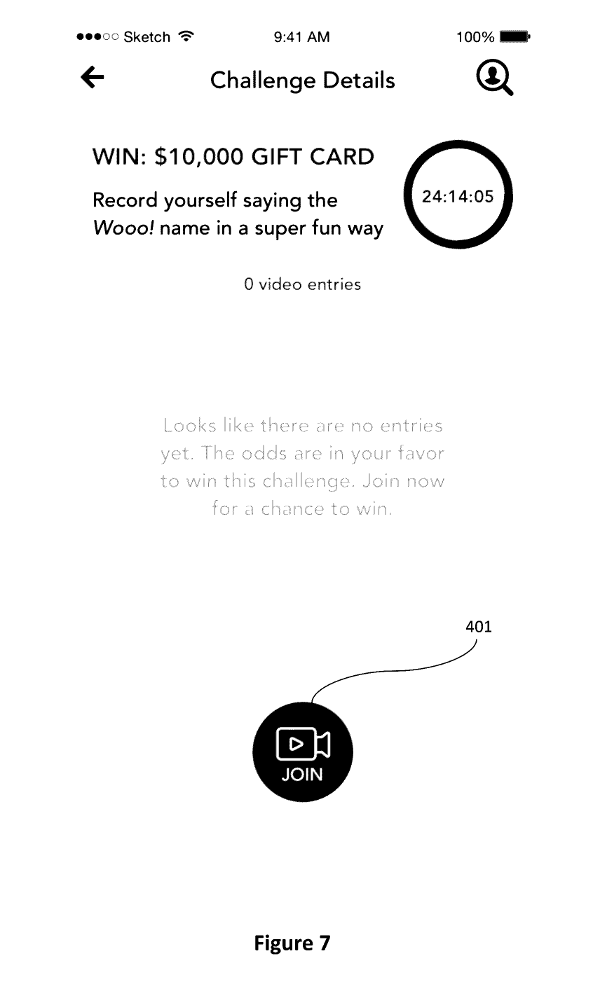

In FIG. 6, one view of a Live listing of challenges or contests may provide a scrollable view of live contests 400. A time element as at 402 may be shown to indicate the amount of time left prior to expiration of a particular live contest 400. A description of the live contest's prize and/or requirements may be shown as in 403. The type of media contest (video, image, sound, etc.) may be illustrated as at 404, including the current number of entries for that contest. Upon interaction of an area of a contest 400, a user may be directed to a detailed view of the challenge or contest, as at FIG. 7. A user may participate or join in the contest, as at 401, by interacting with a select user interface element such as a button.

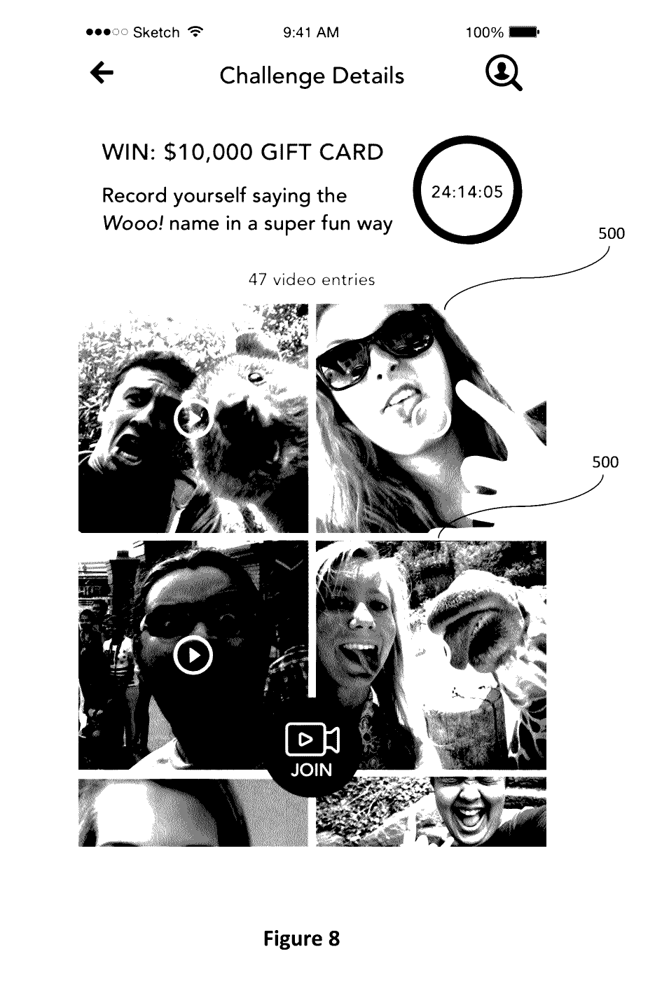

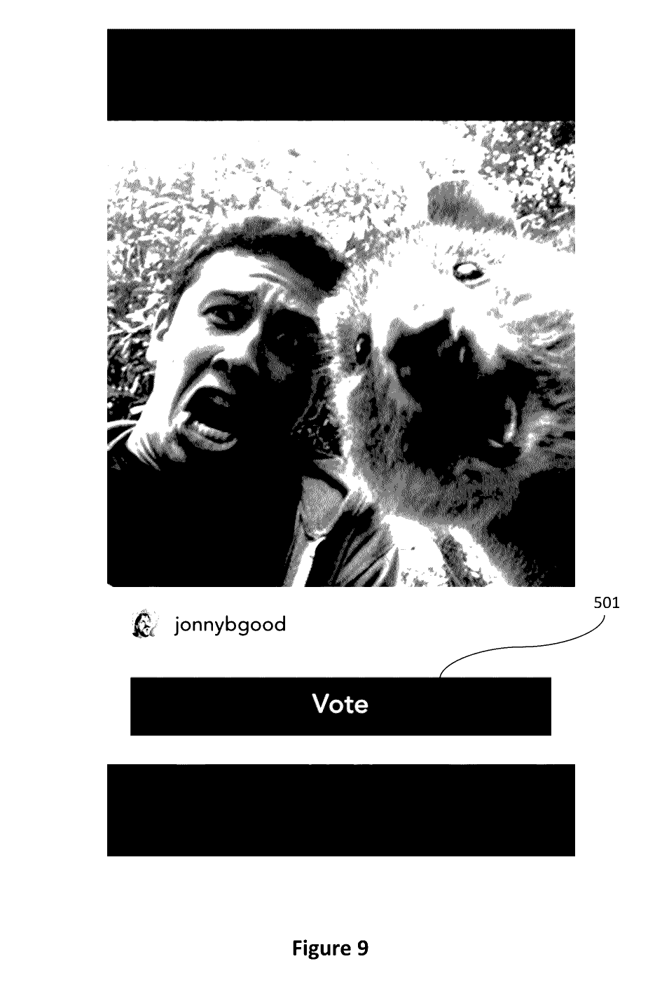

As illustrated in FIG. 8, the user and/or other users of the application server or platform of the present invention may vote on each other's submitted media for a contest or Challenge. Each submitted media 500 from the various users may be separately viewable and vote-able, as indicated in FIG. 9, via a vote button or interactable element 501. In a video recording embodiment, the recording may be initiated by the press and hold of the button 501, and may terminate upon its release. In an image uploading embodiment, the tapping of the button 501 may effect the capture of an image via the used device through an embedded or connected camera. The voting may comprise a simple mechanism as simple as “Like”, a binary mechanism such as “Like” and “Dislike”, or a point system such as a score from 1 to 10 or other appropriate ranges. In one embodiment of a like mechanism, a post with zero likes may be calculated as 1 point. In one embodiment, user(s) may unvote or change his vote after submission of a vote but prior to the expiration of the contest. In one embodiment, user(s) may be incentivized to vote, by awarding instant gratification coupons, such as through the kiip.me platform. A limit of only reward per user for a contest may be implemented.

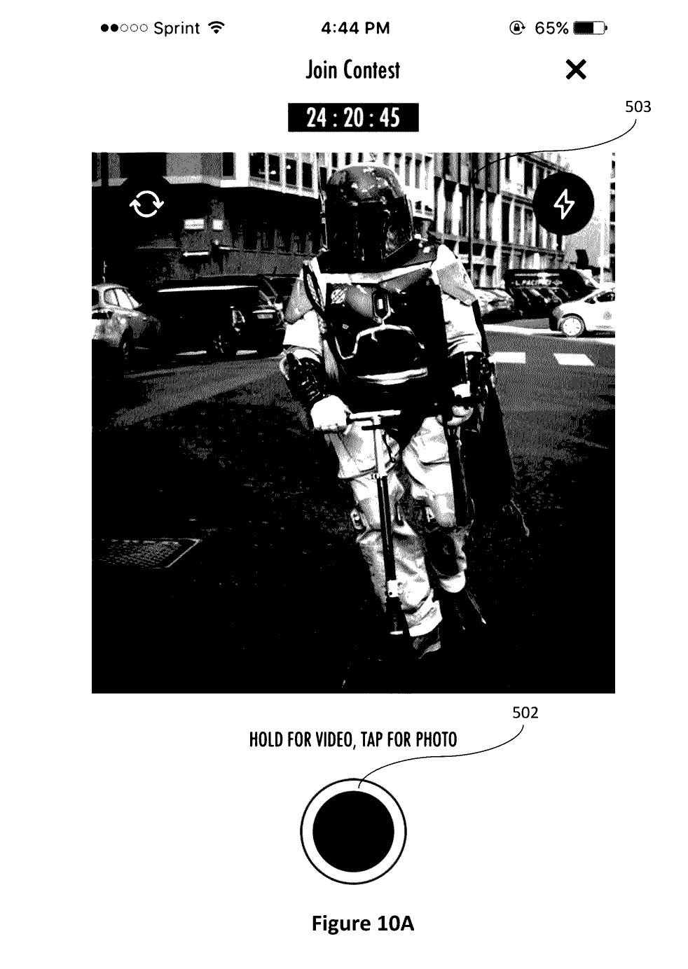

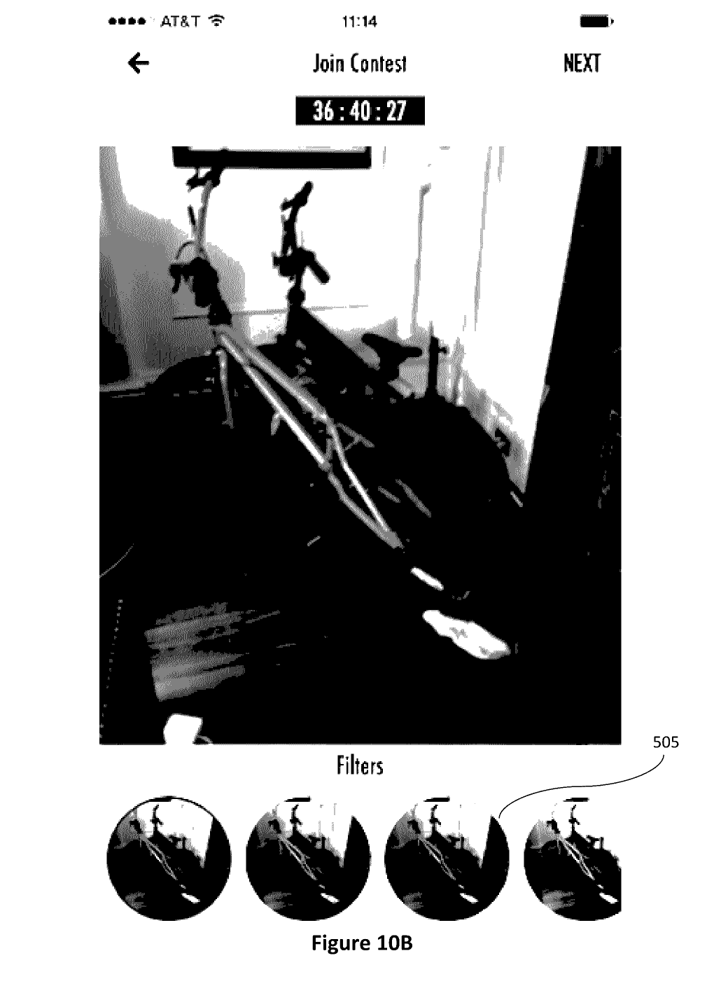

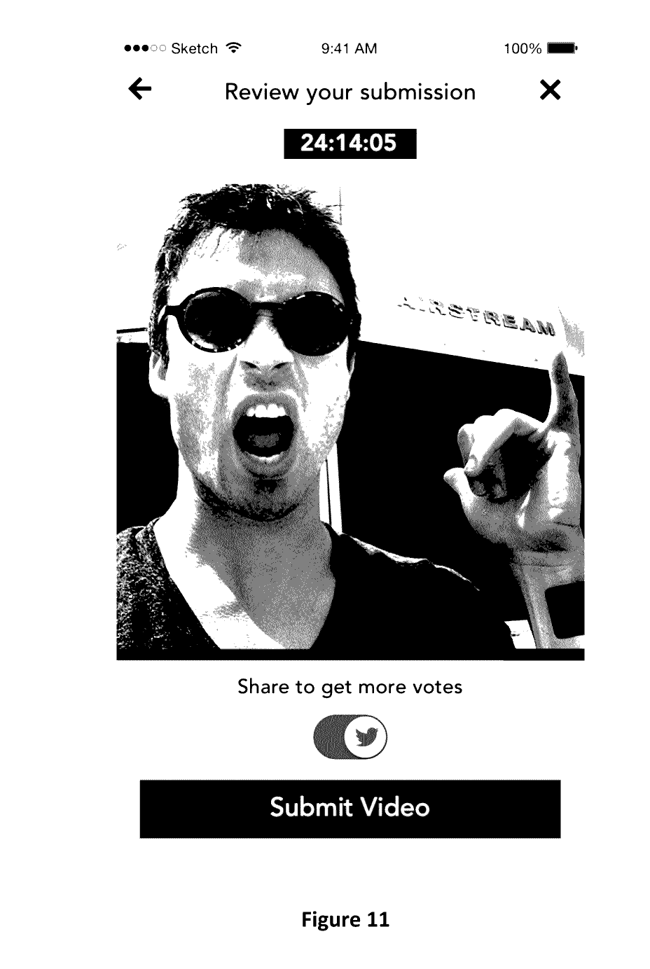

Of course, drawing attention to FIG. 10A, a user may join or participate in a challenge or contest that is live, such as upon interacting with the join button 401 shown in FIG. 7. In a video submission as shown, a user may record a video via a recording button 502, and previous his or her submission at window 503. After recording, a user may submit his or her video submission or other media submission, as illustrated at FIG. 11, and may concurrently share the video via one or more social media platforms in order to obtain more votes. In FIG. 10B, a user may participate in a photo contest. One embodiment of the present invention comprises at least one photo filter 505 a user may apply to his or her image submission.

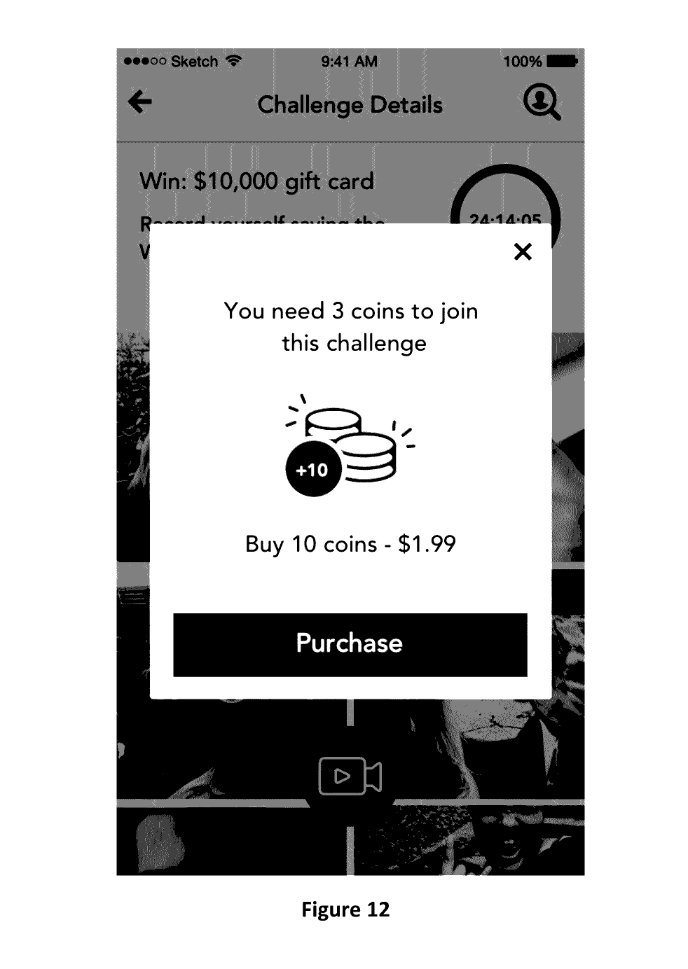

In one embodiment, a purchase via virtual currency, such as “coins”, may be required as a precondition to participating or joining in a contest or Challenge, as illustrated in FIG. 12. Virtual currency acceptable by the platform may be purchasable as in-app purchase(s) via the iTunes, Google Play, Amazon App stores, or via other payment methods known and used by those skilled in the art. In one embodiment, free virtual currency or coins may be provided to the user(s) of the platform or application server upon the performance or meeting of various recharge conditions, such as logging in consecutively to the platform for x number of days, or logging into the server after being inactive for x number of days as an incentive to come back to the application. Coins may also be provided for the performance of various tasks, such as surveys, or via affiliate (inviting friends) and/or marketing link models, i.e. such as upon the clicking or viewing of an advertisement. In other embodiments, no purchase may be required as a precondition for participating in various contests or Challenges.

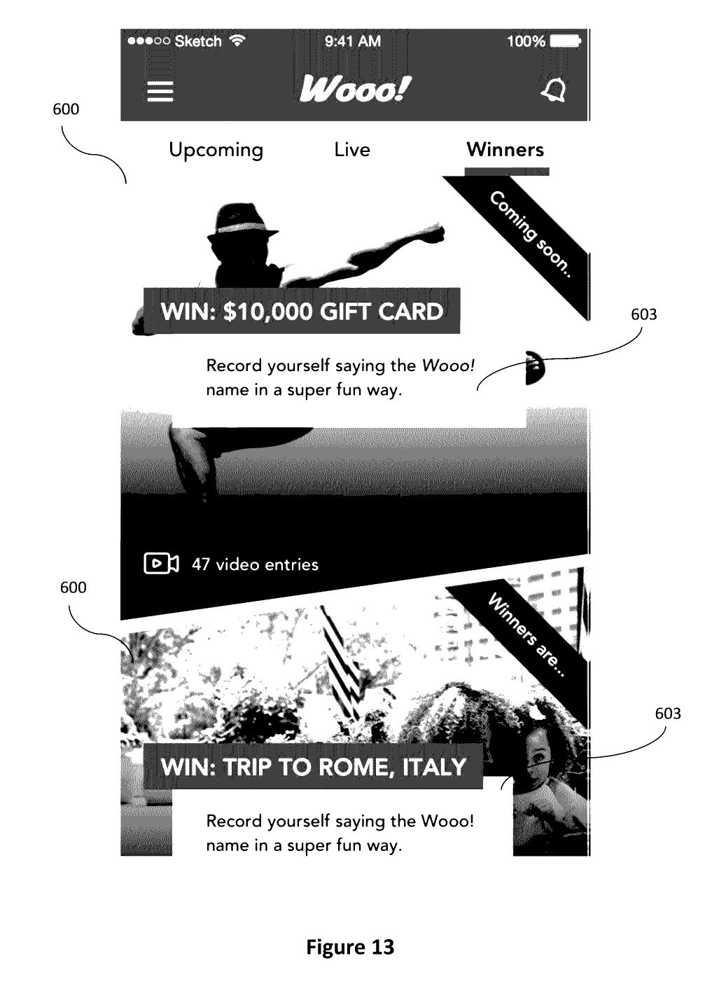

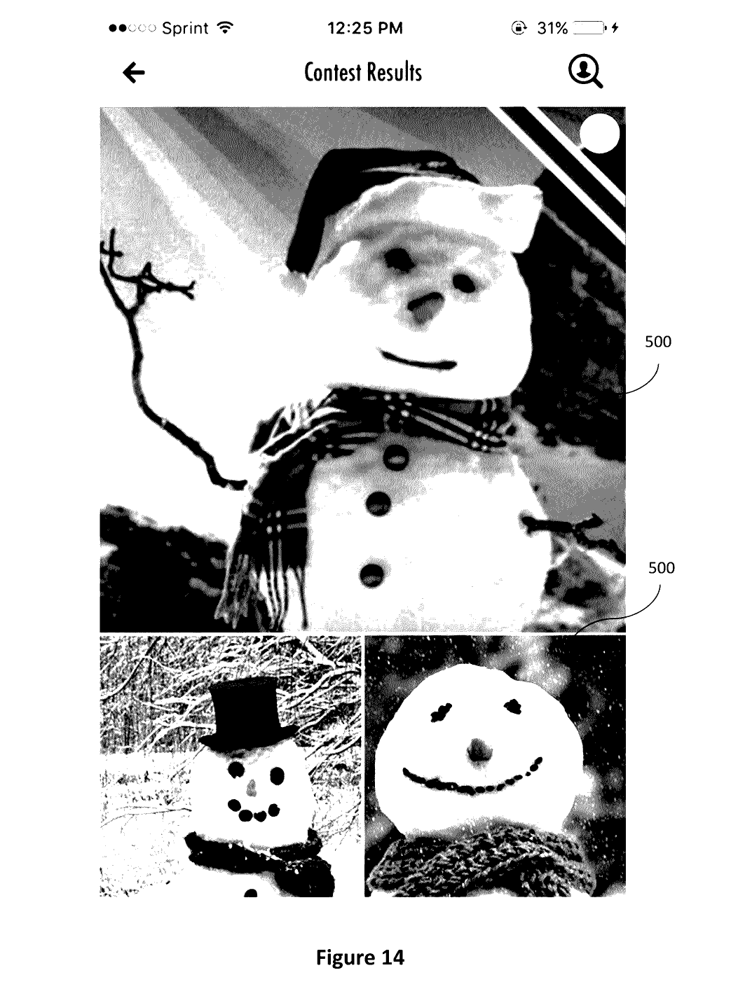

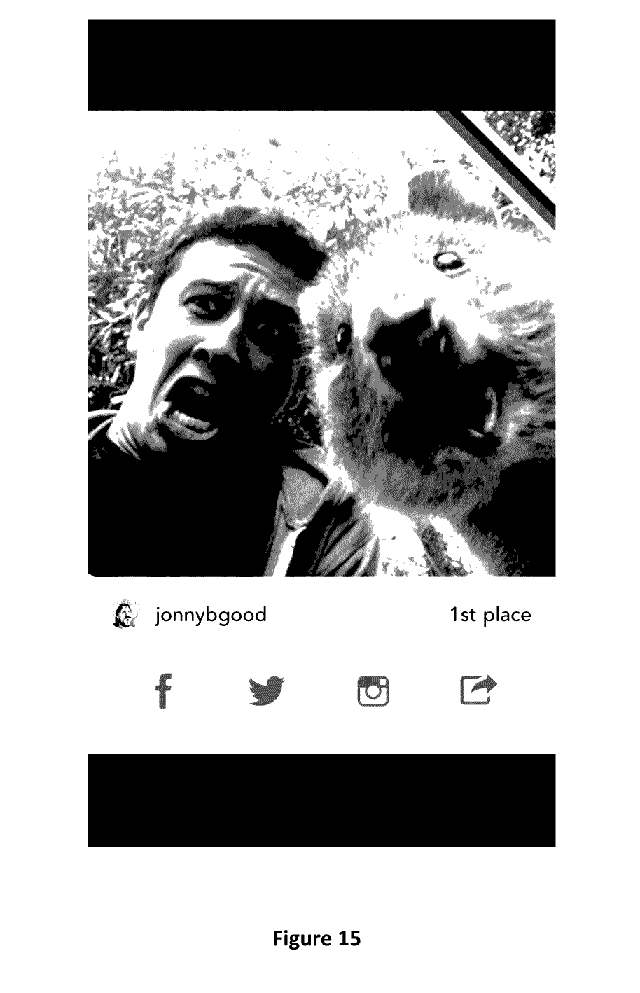

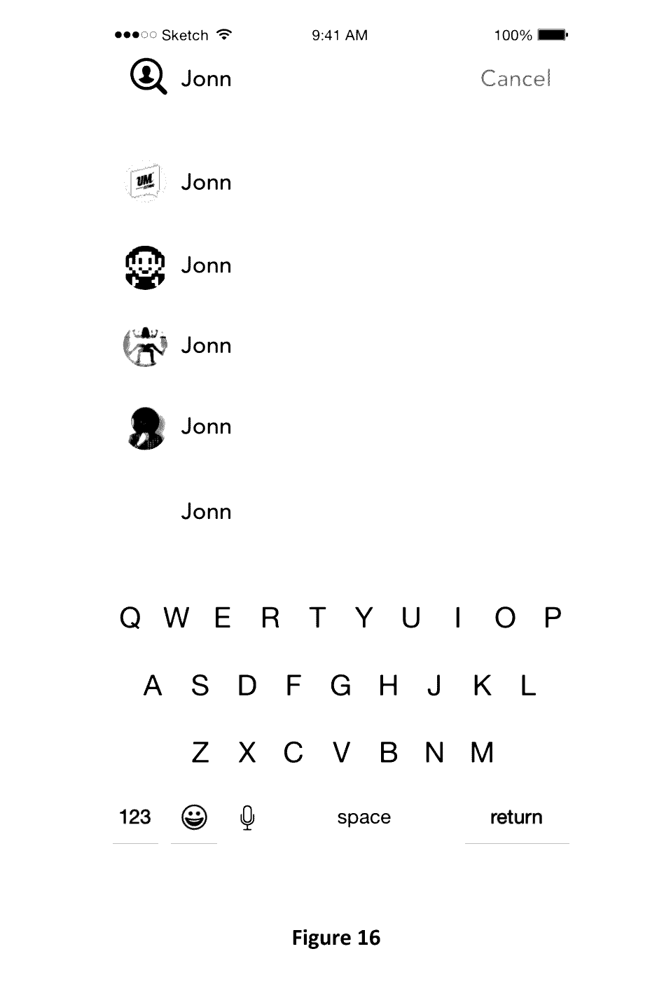

Drawing attention to the “Winners” list of FIG. 13, this tab or list may refer to past contests 600 that have ended having descriptions 603 thereof, upon interaction with each contest 600, a user may view previous entries and the winning entry or entries, similar to those features of the Upcoming and Live contests described above. Upon interaction with a contest listed in the Winners view, a list of winner submissions 500, sorted in priority of first, second, third places, may be shown as illustrated in FIG. 14 in descending order of interface sizes. Upon interaction with each of these submissions, a user may view the submitted media, and may share the media across various social platforms as illustrated in FIG. 15. Drawing attention to FIG. 16, a separate interface for searching through users may also be provided in one embodiment, including autocomplete features as is known in the art. Upon click through of this search interface to a user's profile, the user's information as well as any previous media submissions, may similarly be viewable and/or shareable.

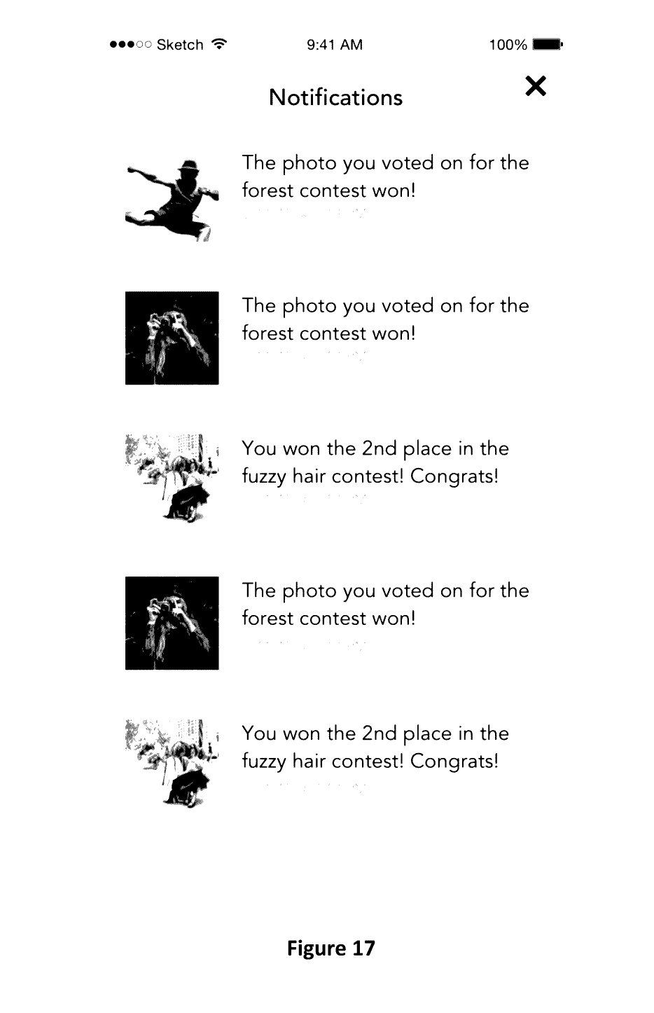

FIG. 17 further illustrates a notification function of the present invention, which may comprise a list of notices sent to the user, including contests a user participated in, media the user voted on, and the statuses thereof, such as if one or more of the contests resulted in a top x place winner.

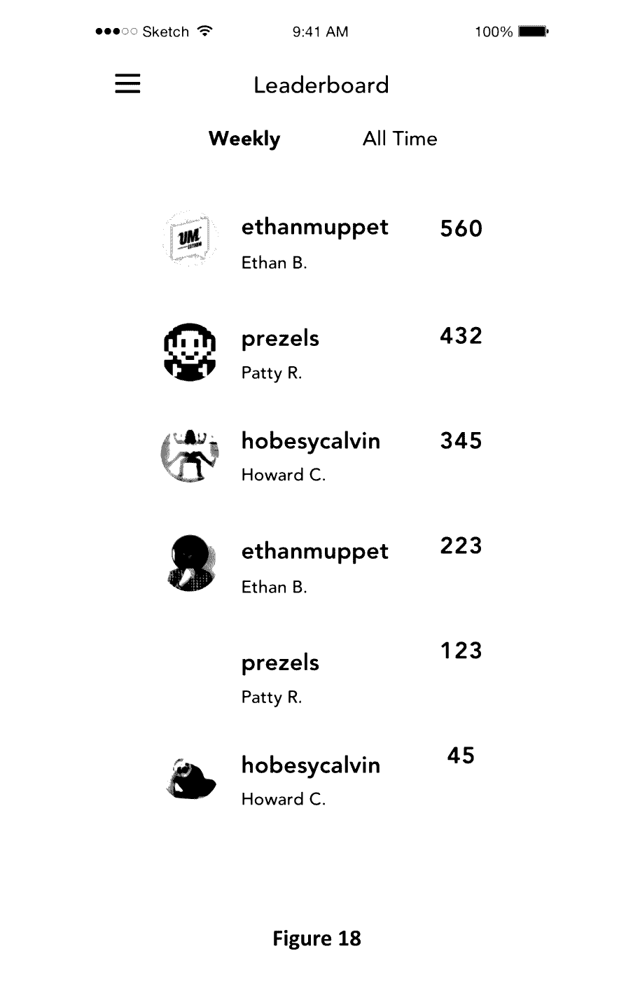

FIG. 18 illustrates a leaderboard function of the present invention, which may comprise a list of the most voted or highest voted users partitioned by day, week, or all time.

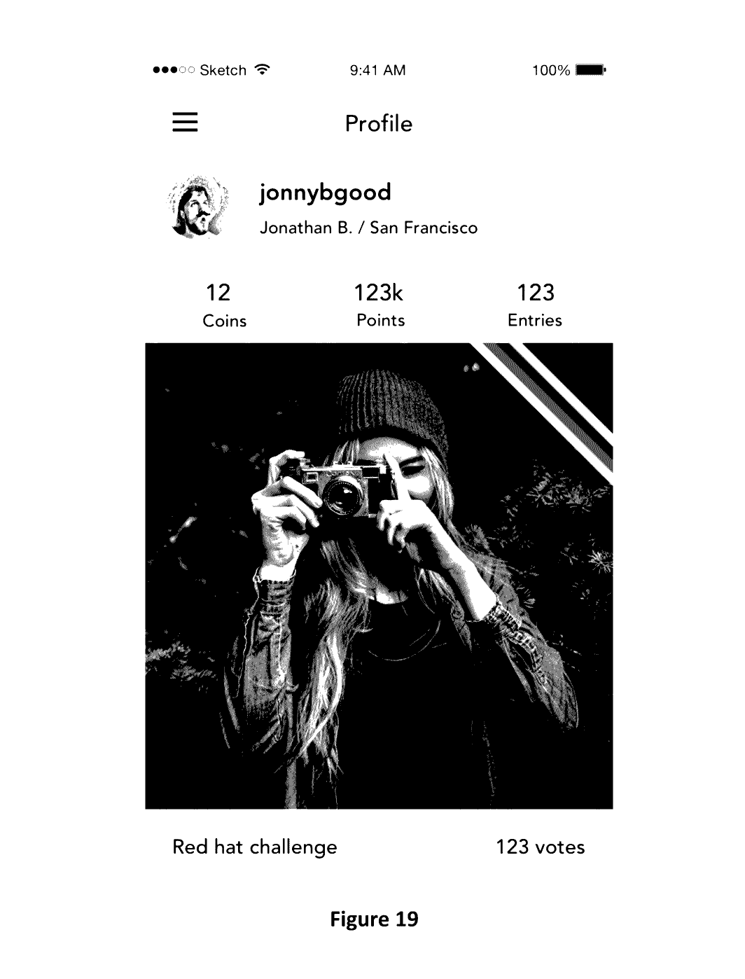

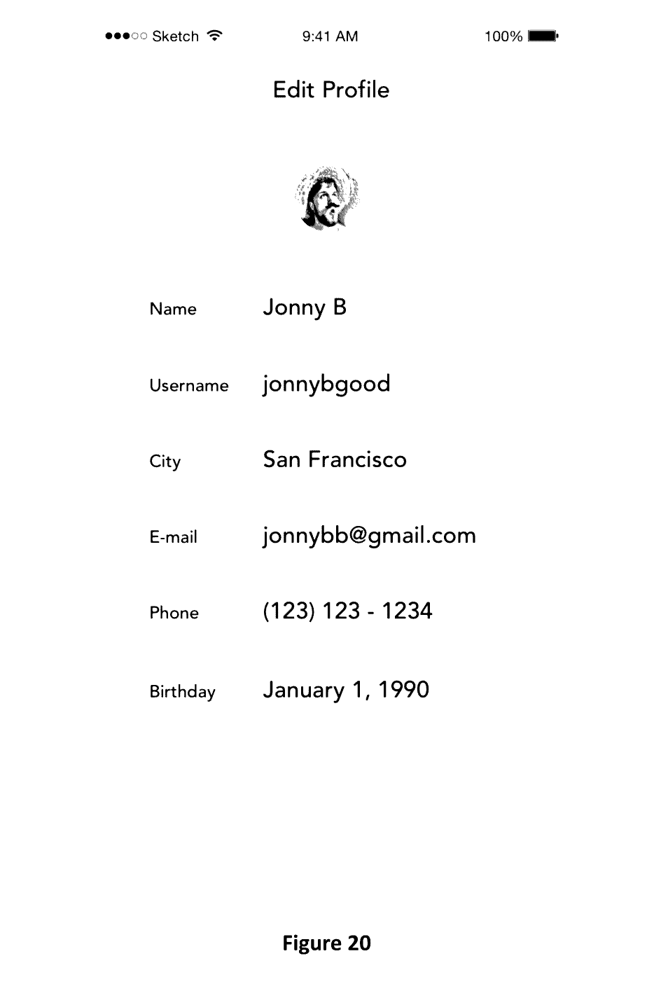

FIG. 19 illustrates a profile function of the present invention, in which a user of the present platform may edit his or her own profile, or view the profiles of other users. A profile view of a user's own profile may show the number of coins or virtual currency the user has available, the total number of points (calculated by media that user submitted for example), the number of entries or contests a user participated in, etc. A user may edit his or her own profile as in FIG. 20, comprising demographic information and other relevant information.

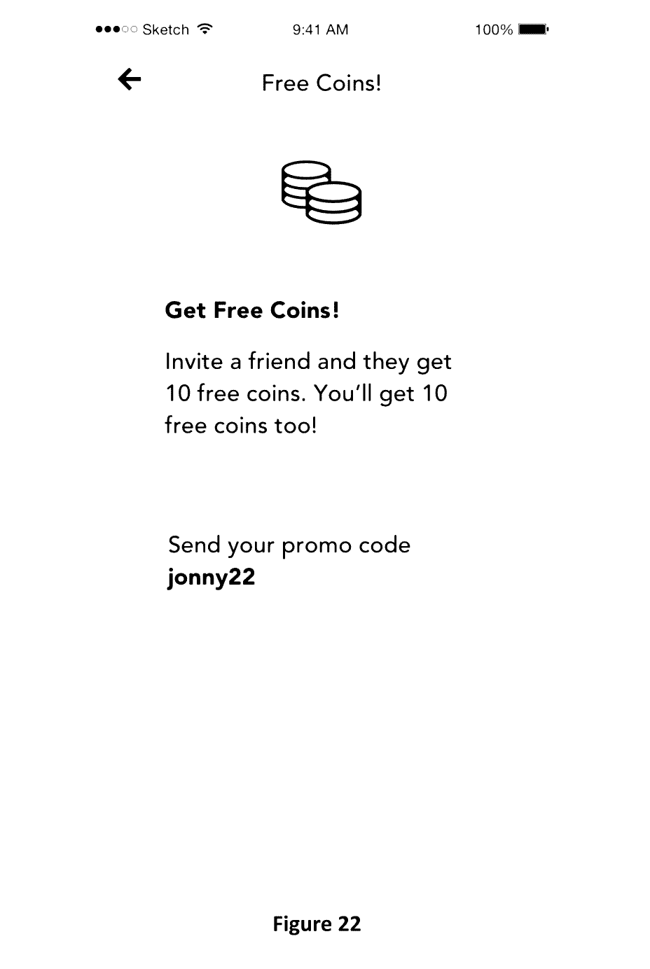

FIG. 20 illustrates a settings function of the present invention, where a user may navigate to other portions of the application, such as Free Coins of FIG. 22, which illustrates one embodiment of the present invention that provides for free coins in an affiliate referral system, whereby a user may earn free coins upon invitation and/or signing up of friends. FIG. 23 illustrates a notification setting menu, in which a user may define the type of notification the application server may push or send to that user.

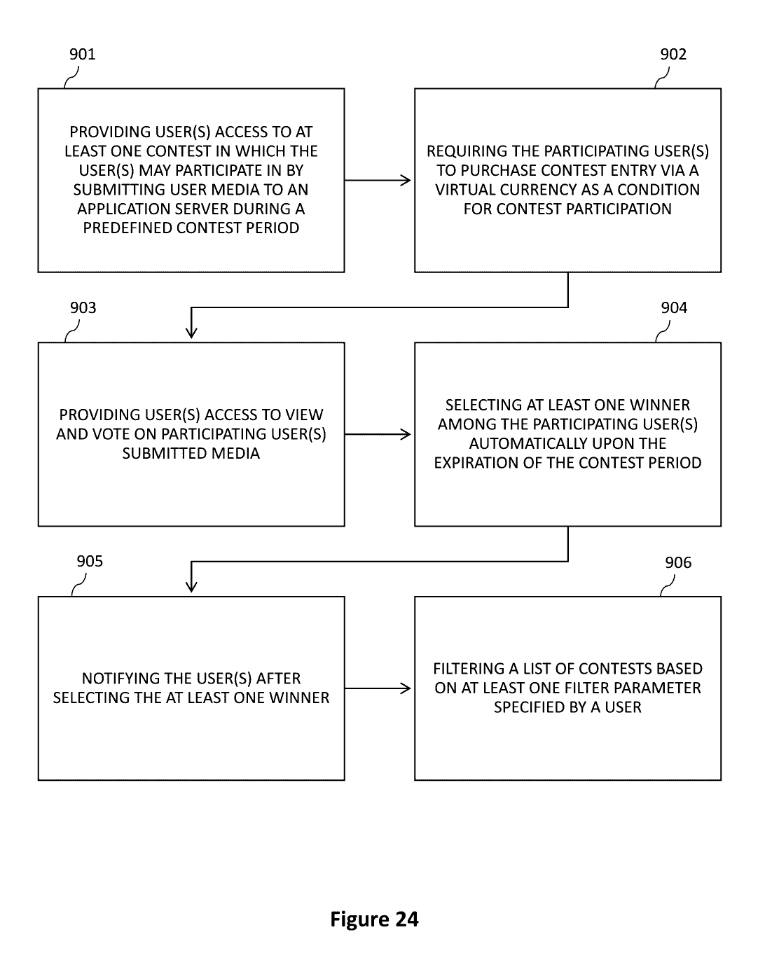

Drawing attention to FIG. 24, a method of the present invention may comprise providing user(s) access to at least one contest in which the user(s) may participate in by submitting user media to an application server during a predefined contest period, as in 901. User(s) may participate in a plurality of contests at a time. A user may access the application server via a user device such as a client device such as a mobile device or computer as described above. A user may access the application server via a mobile application interface installed on the client device, or via a browser accessing the application server as a software-as-a-service. Next, optionally, in 902, participating user(s) may be required to purchase a contest entry via a virtual currency as a condition for contest participation. In other embodiments, contest(s) may be offered for free. In some embodiments, user(s) may be provided with a predetermined amount of virtual currency upon satisfaction of various recharge conditions described above. These recharge conditions may include, for example, logging into the application and/or application server after a predetermined period of inactivity, or logging into the application or application server consecutively for x number of days.

User(s) are further provided with access to view and vote on participating user(s) submitted media, as in 903. The view and voting mechanisms may be implemented according to the wireframes and screenshots described in detail above. For example, a list of current contests, upcoming contests, previous contests (winners), and/or combinations thereof, may be provided to users in a list format which may also be searchable. In one embodiment, administrators may check the submissions and delete inappropriate submissions and/or ban problematic user(s).

Upon expiration of the contest period, at least one winner is chosen among the participating user(s) automatically, as in 904, at the application server. The winner(s) may be selected based on those participating user(s) having the largest number of votes or likes, or having the highest rated votes. In one embodiment, a top x number of user(s) may be automatically selected as winner(s) upon expiration of a contest period.

User(s) may be notified after at least one winner is selected at the application server, as in 905. In one embodiment, only participating user(s) may be notified. In another embodiment, user(s) may be notified if they have requested to be notified. User(s) may also be notified of an upcoming event, upon the user's request, or of a nearby contest within a predefined proximity of a geolocation coordinate received from the user's device.

Optionally, user(s) may also filter a list of contests based on at least one filter parameter, as in 906, specified by a user. In various embodiments, user(s) may filter the list of upcoming events, live events, and/or previous events. The filter parameters may include a selected start time, a prize amount or type, a contest media type for submission.

In one embodiment, user(s) may search for other user(s) of the contest platform, for viewing their respective media entries and winning history, and also for messaging, friending, and/or other known social media functionalities.

In other embodiments not shown, a contest may be created by an administrator user and/or by a sponsor user via separate interfaces (i.e. a merchant or advertising user). As such, a contest period (start day, time, contest time period in days, hours, and/or minutes) may be adjustable by a user creating the contest, with form fields for setting a description, at least one prize or prize pool, and various rules or other general information relating to a contest. For example, a contest or Challenge may relate to a product or brand, i.e. “show us what you do with brand X product”, or may relate to various categories, such as sports or arts, or may merely comprise an instruction line such as “do a funny dance”, “tell a joke”, “sing a song related to X Y Z”, and other themes or types of instructions, for engaging a targeted user base. In various embodiments, user(s) may be able to withdraw virtual currency such as coins form his or her account as real currency.

Individual components or elements of the system and method may be used interchangeably. The order of the method or processes described above may be arranged in any combination in various embodiments. In some embodiments, various steps may be omitted.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents.

Now that the invention has been described,

What is claimed is:

1. A method for providing a time based media contest for user(s) of an application server comprising:
providing user(s) access to at least one contest in which the user(s) may participate in by submitting user media to an application server during a predefined contest period,
wherein the submitted user media are viewable and may be voted on by other users of the application server during the contest period,
wherein a winner is chosen among the participating user(s) automatically upon the expiration of the contest period.

2. The method as recited in claim 1 further comprising:
requiring the participating user(s) to purchase contest entry via a virtual currency as a condition for contest participation.

3. The method as recited in claim 2 further comprising:
providing the user(s) with a predetermined amount of virtual currency upon the satisfaction of a recharge condition.

4. The method as recited in claim 3 wherein the recharge condition comprises logging into the application server after a predetermined period of inactivity.

5. The method as recited in claim 3 wherein the recharge condition comprises logging into the application server consecutively for a predetermined number of days.

6. The method as recited in claim 1 further comprising providing user(s) access to a list of current contests.

7. The method as recited in claim 6 further comprising providing user(s) access to a list of upcoming contests.

8. The method as recited in claim 7 further comprising:
notifying a user of an upcoming contest, upon the user's request.

9. The method as recited in claim 8 further comprising:
notifying a user of a nearby contest within a predefined proximity of a geolocation coordinate received from the user's device.

10. The method as recited in claim 7 further comprising:
filtering the list of upcoming contests based on a selected start time defined by a user.

11. The method as recited in claim 10 further comprising:
filtering the list of upcoming contests based on a prize amount defined by the user.

12. The method as recited in claim 7 further comprising:
filtering the list of upcoming contests based on a media type defined by the user.

13. The method as recited in claim 1 wherein said predefined contest period is adjustable by a user creating the contest.

14. A computer program on a non-transitory computer readable medium, for execution by a computer for providing a time based media contest platform comprising:
a contest code segment for providing user(s) access to at least one contest in which the user(s) may participate in by submitting user media to an application server during a predefined contest period,
wherein the participating user(s) are required to purchase contest entry via a virtual currency as a condition for contest participation,
wherein the submitted user media are viewable and may be voted on by other users of the application server during the contest period,
wherein a winner is chosen among the participating user(s) automatically upon the expiration of the contest period;
a notification code segment for notifying user(s) of upcoming contests, upon a user's request;
a filtering code segment for filtering the list of upcoming contests based on a filter condition defined by the user.

15. The computer program of claim 14 further comprising a leaderboard code segment for recording and presenting the number of votes each user received for one or more contests.

16. The computer program of claim 14 further comprising a searching code segment for locating one or more users.
